(19) United States
(12) Patent Application Publication
(10) Pub. No.: US 2022/0324105 A1
(43) Pub. Date: Oct. 13, 2022

(54) GRIPPING POSITION DETERMINATION DEVICE, GRIPPING POSITION DETERMINATION SYSTEM, GRIPPING POSITION DETERMINATION METHOD, AND RECORDING MEDIUM

(71) Applicant: Honda Motor Co., Ltd., Tokyo (JP)

(72) Inventors: Masanori YOSHIHIRA, Saitama (JP); Tadaaki HASEGAWA, Saitama (JP)

(73) Assignee: Honda Motor Co., Ltd., Tokyo (JP)

(21) Appl. No.: 17/689,994

(22) Filed: Mar. 9, 2022

(30) Foreign Application Priority Data
Mar. 31, 2021 (JP) 2021-060662

(51) Int. Cl. B25J 9/16

(52) U.S. Cl. CPC B25J 9/1653; B25J 9/1633; B25J 9/1612

(57) ABSTRACT

The disclosure provides a gripping position determination device, a gripping position determination system, a gripping position determination method, and a recording medium. The gripping position determination device for a robot hand having a plurality of multi joint fingers includes: a frictional force distribution calculation part estimating, from a predictive control of a gripping force when an object is gripped by at least two fingers, a frictional force between one of the gripping fingers and the object, and calculates a frictional force distribution where grapping of the object is possible on a surface of the object based on a value related to a frictional force calculated by using the estimated frictional force; a grippable region selection part selecting, from the frictional force distribution, at least one grippable region; and a gripping position calculation part calculating, from the selected grippable region, a gripping position where stable gripping of the object is possible.

### CROSS-REFERENCE TO RELATED APPLICATION

This application claims the priority benefits of Japanese application no. 2021-060662, filed on Mar. 31, 2021. The entirety of the above-mentioned patent application is hereby incorporated by reference herein and made a part of this specification.

### BACKGROUND

### Technical Field

The disclosure relates to a gripping position determination device, a gripping position determination system, a gripping position determination method, and a recording medium.

### Related Art

A control device to make a robot grip an object has been proposed. As such a control device, a method has been proposed to search for a higher quality gripping point by tentatively determining a physically contactable gripping point, determining a gripping force in consideration of the balance of forces, and evaluating the quality of the gripping force as a volume of the envelope of the gripping force (see, for example, Patent Literature 1).

Further, according to the technique described in Patent Literature 2, before actually gripping the object, only a finger is slid on a surface of a target object to be gripped with a predetermined pressing force to detect the pressing force and the frictional force at that time and obtain an estimated friction coefficient from the ratio of the pressing force and the frictional force. Also, according to the technique described in Patent Literature 2, by appropriately controlling the gripping force so as not to become excessive while maintaining the gripping force so as not to cause slippage by using the estimated coefficient of friction obtained, the object is stably gripped with an appropriate gripping force.

FIG. 13 is a diagram for explaining an example in which a robot grips an object (coin-shaped object Obj) with two fingers (upper finger 901 and lower finger 902) according to the prior art. In a first state g901, the inter-finger gap, which is a longitudinal deviation of the coin Obj between the upper finger 901 and the lower finger 902, is 0.0 (m). In a second state g902, the inter-finger gap between the upper finger 901 and the lower finger 902 is 0.0015 (m). A graph g903 shows the relationship between the inter-finger gap including the first state and the second state and a lateral force (sum of squares), in which the horizontal axis is the inter-finger gap (m) and the vertical axis is the lateral force. The lateral force is a sideway force (frictional force) applied to the gripped object. As shown in FIG. 13, when the inter-finger gap increases, the lateral force increases and the gripping state becomes unstable.

FIG. 14 is a diagram for explaining an example in which a robot grips an object (spherical object Obj) with three fingers (first finger 911, second finger 912, and third finger 913) according to the prior art. Graphs g911 to g914 represent a first state to a fourth state. In the graphs g911 to g914, the vertical axis and the horizontal axis are the inter-finger gap (m). In the first state as shown in the graph g911, the angles of the three fingers are 10, 170, 270 degrees, respectively, and the lateral force is 6.21e⁻²³. In the second state as shown in the graph g912, the angles of the three fingers are 10, 170 and 230 degrees, respectively, and the lateral force is 9.81e⁻². When the finger is in a position facing gravity, as in the graphs g911 and g912, the lateral force is minimized. Further, in the third state as shown in the graph g913, the angles of the three fingers are 30, 150, 270 degrees, respectively, and the lateral force is 6.29e⁻²³. In the fourth state as shown in the graph g914, the angles of the three fingers are 70, 150 and 270 degrees, respectively, and the lateral force is 5.72e⁷. As shown in the graphs g913 and g914, the lateral force becomes minimum when the finger positions are symmetrical.

FIG. 15 is a diagram for explaining an example of an index s (see non-patent Literature 1) when the robot grips the object (coin-shaped object Obj) with two fingers (the upper finger 901 and the lower finger 902) with an inter-finger gap of 0.0 (m) according to the prior art. A graph g921 shows the inter-finger gap. A graph g922 shows the index ε in two dimensions, with the horizontal axis representing the force and the vertical axis representing the moment of force. The larger the region surrounded by the chain line, the more stable the gripping state. Thus, the index ε when the fingers face each other in a thickness direction of the object (inter-finger gap 0.0 (m)) is about 5.69e⁶. A graph g923 shows the friction thrust and the force vector of the upper finger, and graph g924 shows the friction thrust and the force vector of the lower finger. In this state, G_{c}f_{c}=−Fₑ is established, and there is sufficient room for gripping. Fₑ is an external force, and G_{c}f_{c} is a force that the robot may exert when gripping. The condition for establishing the force closure is that G_{c}f_{c}=−Fₑ is established for an arbitrary external force Fₑ∈R⁶.

FIG. 16 is a diagram for explaining an example of an index ε (see non-patent Literature 1) when the robot grips the object (coin-shaped object Obj) with two fingers (the upper finger 901 and the lower finger 902) with an inter-finger gap of 0.0015 (m) according to the prior art. A graph g931 shows the inter-finger gap. A graph g932 shows the index ε in two dimensions. As described above, the index E when the inter-finger gap 0.0015 (m) is deviated is about 1.21e⁵. A graph g933 shows the friction thrust and the force vector of the upper finger, and a graph g934 shows the friction thrust and the force vector of the lower finger. In this state, G_{c}f_{c}=−Fₑ is established, but there is little room for gripping.

### CITATION LIST

### Patent Literature

[Patent Literature 1] Japanese Patent No. 6476358
[Patent Literature 2] Japanese Unexamined Patent Publication No. 2005-144573

### Non-Patent Literature

[Non-patent literature 1] Andrew T. Miller Peter K. Allen, “GraspIt!: A Versatile Simulator for Grasp Analysis”, IEEE Robotics & Automation Magazine (Volume: 11, Issue: 4, December 2004), 2004, p 110-122.

However, in the prior art, when only certain fingers are moved along the surface of an object under the same number of finger contacts, the index ε and volume v, which are general-purpose gripping characteristics, do not necessarily mean that the size of the index is actually directly related to the slipperiness of the finger, and the finger may slip. As a result, the evaluation of the index E may misinterpret even an unstable state as shown in FIG. 16 as a stable state.

Further, according to the technique described in Patent Literature 2, before actually gripping the object, only a finger is slid on the surface of the target object to be gripped by a predetermined pressing force so as to estimate the coefficient of friction, but the contact position of the tip is restricted due to position correction, and there is no degree of freedom. With the technique described in Cited Literature 2, for example, when the surface of the target object is a curved surface, the coefficient of friction cannot be estimated.

As described above, in the prior art, it is difficult to determine the gripping point in consideration of the operation.

The disclosure has been made in view of the above problems, and an object thereof is to provide a gripping position determination device, a gripping position determination system, a gripping position determination method, and a program capable of determining a gripping point in consideration of the operation.

### SUMMARY

(1) The gripping position determination device according to one aspect of the disclosure is a gripping position determination device for a robot hand having a plurality of multi-joint fingers. The gripping position determination device includes: a frictional force distribution calculation part that estimates, from a predictive control of a gripping force when an object is gripped by at least two of the plurality of fingers, a frictional force between one of the gripping fingers and the object, and calculates a frictional force distribution where gripping of the object is possible on a surface of the object based on a value related to a frictional force calculated by using the estimated frictional force; a grippable region selection part that selects, from the frictional force distribution, at least one grippable region; and a gripping position calculation part that calculates, from the selected grippable region, a gripping position where stable gripping of the object is possible.

(8) The gripping position determination system according to one aspect of the disclosure is a gripping position determination system. The gripping position determination system includes the gripping position determination device according to any one of (1) to (7) above; a robot hand having a plurality of multi joint fingers; an environment sensor installed in a robot having the robot hand or in a surrounding environment of the robot and detecting a robot environment sensor value; and a control part that controls, based on the gripping position determined by the gripping position determination device, a movement of the robot hand so as to grip the object.

(9) The gripping position determination method according to one aspect of the disclosure is a gripping position determination method for a robot hand having a plurality of multi joint fingers. The gripping position determination method includes: a frictional force distribution calculation part estimating, from a predictive control of a gripping force when an object is gripped by at least two of the plurality of fingers, a frictional force between one of the gripping fingers and the object, and calculating a frictional force distribution where gripping of the object is possible on a surface of the object based on a value related to a frictional force calculated by using the estimated frictional force; a grippable region selection part selecting, from the frictional force distribution, at least one grippable region; and a gripping position calculation part calculating, from the selected grippable region, a gripping position where stable gripping of the object is possible.

(10) a recording medium, recording a program according to one aspect of the disclosure causes a computer of a gripping position determination device of a robot hand having a plurality of multi joint fingers to estimate, from a predictive control of a gripping force when an object is gripped by at least two of the multiple fingers, a frictional force between one of the gripping fingers and the object, and calculate a frictional force distribution where gripping of the object is possible on a surface of the object based on a value related to a frictional force calculated by using the estimated frictional force; select, from the frictional force distribution, at least one grippable region; and calculate, from the selected grippable region, a gripping position where stable gripping of the object is possible.

### BRIEF DESCRIPTION OF THE DRAWINGS

FIG. 1 is a diagram showing an example in which a gripping part of a robot according to an embodiment grips a target object with fingers.

FIG. 2 is a block diagram showing a configuration example of a gripping position determination system according to a first embodiment.

FIG. 3 is a diagram for explaining a gripping part position determining process according to the first embodiment.

FIG. 4 is a flowchart of a processing procedure for determining a gripping position according to the first embodiment.

FIG. 5 is a diagram for explaining a method of calculating a L2 norm according to the embodiment.

FIG. 6 is a diagram showing an example of an initial gripping position, a frictional force distribution, and a correction position when gripping a smartphone having a curved surface at an edge.

FIG. 7 is an image diagram of searching from an initial gripping position to a correction position.

FIG. 8 is a diagram showing an example of a track and waypoints.

FIG. 9 is a block diagram showing a configuration example of a gripping position determination system according to a second embodiment.

FIG. 10 is a diagram for explaining a gripping position determination example of the second embodiment.

FIG. 11 is a diagram showing an example of frictional force distribution in the second embodiment.

FIG. 12 is a flowchart of a processing procedure for determining a gripping position according to the second embodiment.

FIG. 13 is a diagram for explaining an example in which a robot grips an object with two fingers according to the prior art.

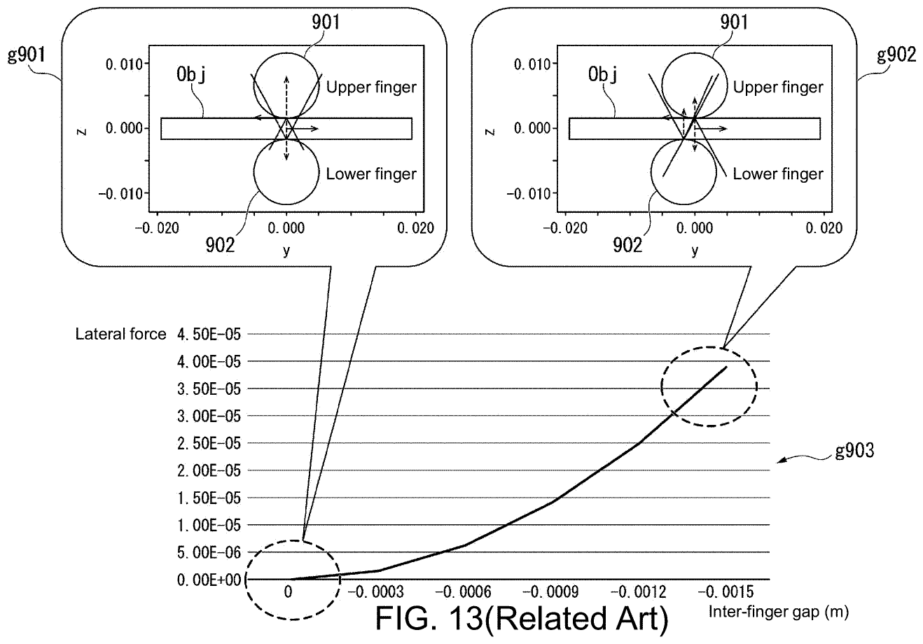

FIG. 14 is a diagram for explaining an example in which a robot grips an object with three fingers according to the prior art.

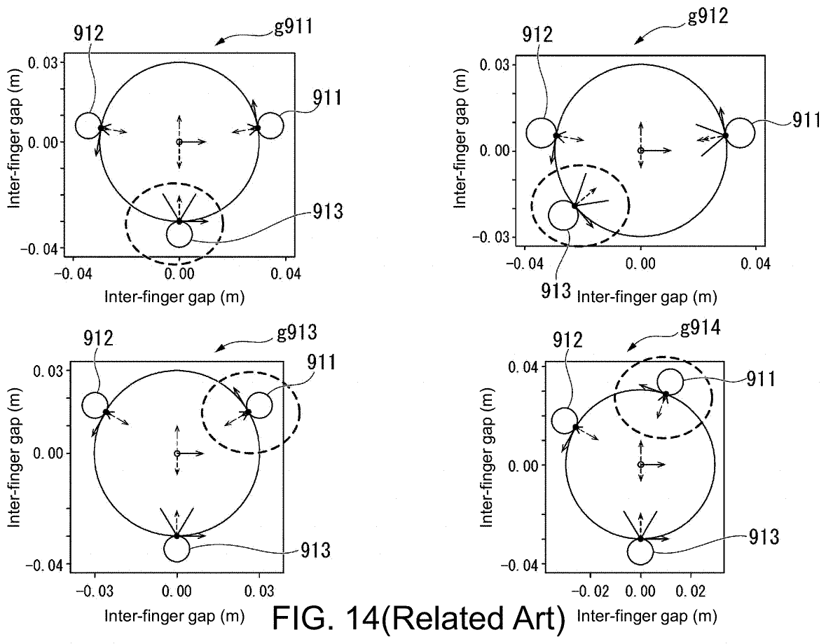

FIG. 15 is a diagram for explaining an example of an index ε when a robot grips an object with two fingers with an inter-finger gap of 0.0 (m) according to the prior art.

FIG. 16 is a diagram for explaining an example of an index 6 when a robot grips an object with two fingers with an inter-finger gap of 0.0015 (m) according to the prior art.

### DESCRIPTION OF THE EMBODIMENTS

Hereinafter, embodiments of the disclosure will be described with reference to the drawings. In the drawings used in the following description, the scale of each member is appropriately modified so as to make each member recognizable.

[Overview]

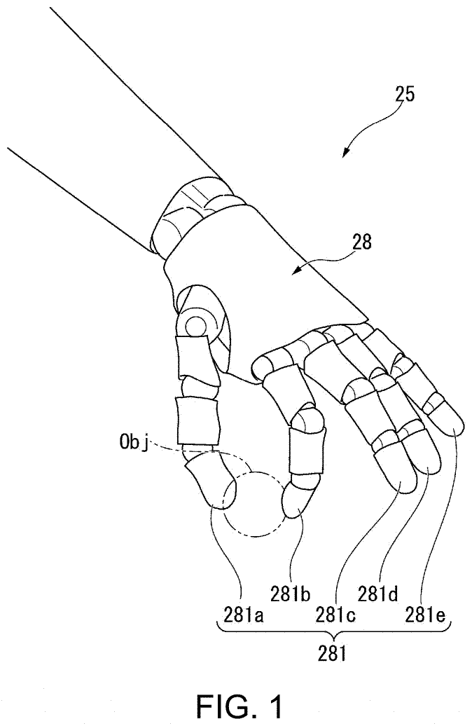

FIG. 1 is a diagram showing an example in which a gripping part 28 of a robot according to the embodiment grips a target object Obj with a finger part 281.

The robot includes the gripping part 28 with at least two finger parts 281. In the embodiment, when the gripping part 28 of the robot grips the target object Obj, a robust gripping position can be determined even if there is an error in shape or in control by directly incorporating the magnitude of the frictional force at the gripping position into the evaluation formula and performing an evaluation in consideration of an error in the gripping position at the time of actual gripping.

Further, the robot selects a grippable region based on frictional force and gravity, and estimates a stable grippable position within the grippable region and a posture of the gripping part (posture of fingers or hand joints).

### First Embodiment

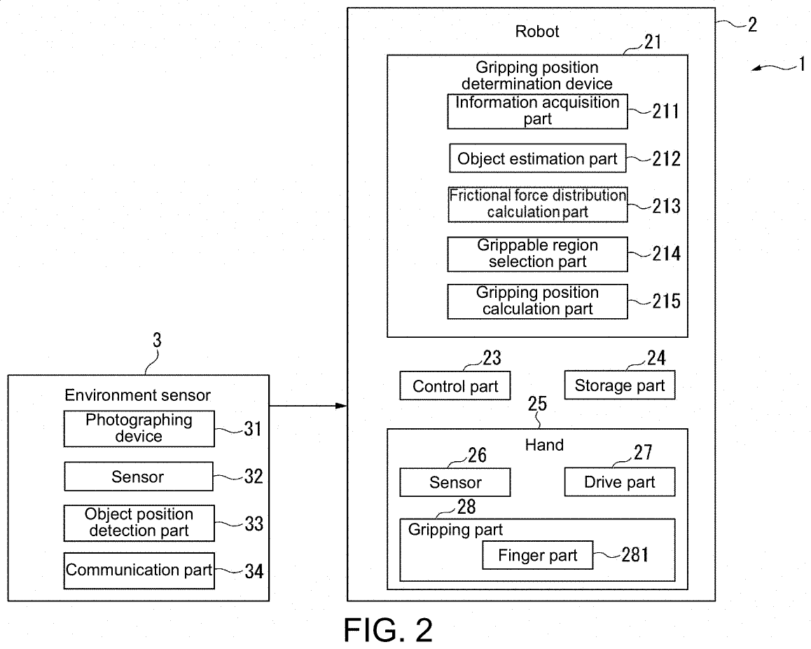

FIG. 1 is a block diagram showing a configuration example of a gripping position determination system according to the present embodiment. As shown in FIG. 2, a gripping position determination system 1 includes a robot 2 and an environment sensor 3.

The robot 2 includes a gripping position determination device 21, a control part 23, a storage part 24, and a hand 25 (robot hand). The robot 2 may further include legs, a head, a torso, a waist, and the like in addition to the hand 25, for example. Further, the robot 2 is provided with a power supply (not shown). The power supply supplies electric power to each part of the robot 2. The power supply may include, for example, a rechargeable battery or a charging circuit.

The gripping position determination device 21 includes an information acquisition part 211, an object estimation part 212, a frictional force distribution calculation part 213, a grippable region selection part 214, and a gripping position calculation part 215.

The hand 25 includes a sensor 26, a drive part 27, and a gripping part 28.

The gripping part 28 includes a finger part 281. The finger part 281 includes at least two fingers. In FIG. 1, the finger part 281 is an example including five fingers (thumb 281a, index finger 282b, middle finger 282c, ring finger 282d, and little finger 282e). The hand 25 of the present embodiment includes a plurality multi-joint fingers.

The environment sensor 3 includes a photographing device 31, a sensor 32, an object position detection part 33, and a communication part 34.

The robot 2 and the environment sensor 3 are connected to each other via, for example, a wireless or wired network. The robot 2 and the environment sensor 3 may be directly connected to each other without going through a network.

[Function of Gripping Part Control System]

The environment sensor 3 is installed at a position where, for example, a target object to be operated may be photographed and detected. The environment sensor 3 may be provided in the robot 2 or may be attached to the robot 2. Alternatively, the environment sensors 3 may plural, and may be installed in the work environment and also attached to the robot 2. The environment sensor 3 detects the position information of the object based on the captured image and the detection result detected by the sensor, and transmits the detected object position information (environment sensor value) to the robot 2.

The photographing device 31 is, for example, an RGB camera. The photographing device 31 outputs the captured image to the object position detection part 33. In the environment sensor 3, the positional relationship between the photographing device 31 and the sensor 32 is known.

The sensor 32 is, for example, a depth sensor. A sensor 72 outputs the detection result to the object position detection part 33.

The object position detection part 33 detects the three-dimensional position, size, shape, and the like of the target object in the captured image based on the captured image and the detection result detected by the sensor by a well-known method. The object position detection part 33 refers to a pattern matching model or the like stored in the object position detection part 33, and performs image processing (edge detection, binarization processing, feature amount extraction, image enhancement processing, image extraction, pattern matching processing, etc.) on the image captured by the photographing device 31 to estimate the position of the object. When a plurality of objects are detected from the captured image, the object position detection part 33 detects the position of each object. The object position detection part 33 transmits the detected object position information (environment sensor value) to a robot remote control device 30 via the communication part 34.

The communication part 34 transmits the object position information to the robot 2.

The robot 2 controls gripping according to the gripping position information determined by the gripping position determination device 21.

The control part 23 controls the drive part 27 based on the gripping position information output by the gripping position determination device 21.

The storage part 24 stores, for example, a program, a threshold value, or the like configured in the control part 23 for control.

The sensor 26 is, for example, a joint encoder or the like. The sensor 26 is attached to each joint of the robot 2, for example. The sensor 26 outputs the detected detection result to the gripping position determination device 21 and the control part 23.

The drive part 27 drives the gripping part 28 of the robot 2 according to the control of the control part 23. The drive part 27 includes, for example, an actuator, a gear, an artificial muscle, and the like.

The information acquisition part 211 acquires object position information (environment sensor value) from the environment sensor 3. The information acquisition part 211 outputs the acquired object position information to the object estimation part 212 and the control part 23.

The object estimation part 212 estimates the position, size, shape, inclination, and the like of the object to be gripped by a well-known method using the object position information. The object estimation part 212 may also estimate the type and name of the object by a pattern matching method or the like.

The frictional force distribution calculation part 213 calculates the frictional force distribution of at least one finger based on the external force (including gravity) applied to the object, the position of the contact point with the typical part of the finger (for example, the tip of the finger and the pad of the finger) on the object Obj in the object coordinate system, and the orientation (including the number) of each contact point on the object Obj in the object coordinate system. In other words, the frictional force distribution calculation part 213 calculates the force to be exerted at each contact point within a range of the control target value required for the robot 2 to grip the object Obj against the external force. The frictional force distribution calculation part 213 estimates the lateral force (frictional force) within a predetermined range from the initial gripping position, and calculates the frictional force distribution on the surface of the object by calculating the value related to the frictional force by using the estimated lateral force. In other words, the frictional force distribution calculation part 213 estimates the frictional force between the object and the fingers from the prediction control of the gripping force.

The value related to the frictional force is, for example, a L2 norm (=√(Fx²+Fy²)) which is the square root of the sum of squares of the estimated frictional force.

Alternatively, the value related to the frictional force is, for example, the sum of squares of the estimated frictional force (Fx²+Fy²). When the estimated frictional force is small, in some cases, evaluation may be easier because the change is larger without taking a square root.

Alternatively, the value related to the frictional force is, for example, the sum of squares of the estimated frictional force divided by a normal force ([Fx²+Fy²]/Fz²). The frictional force changes according to Fz. For example, when Fz is large, the sum of squares of the frictional force tends to be large. Even the value related to the frictional force calculated in this way may have a large change and be easy to evaluate.

In the following embodiments, the case where the L2 norm is taken as an example of the value related to the frictional force will be described, but the disclosure is not limited thereto.

The grippable region selection part 214 selects at least one grippable region within the region of the frictional force distribution based on the L2 norm. The grippable region selection part 214 selects, for example, a region having the L2 norm of a predetermined value or more in the region of the frictional force distribution as the grippable region.

The gripping position calculation part 215 searches the grippable region and calculates the gripping position (contact point of finger) that can most resist the external force. The gripping position calculated by the gripping position calculation part 215 is a position where the frictional force between the object and the fingers is minimized.

[Example of Gripping Position Determining Process]

Next, the gripping part position determining process of the present embodiment will be described. According to the present embodiment, the gripping position determination device 21 determines the position to be gripped by the finger part 281 of the gripping part 28 before gripping the object.

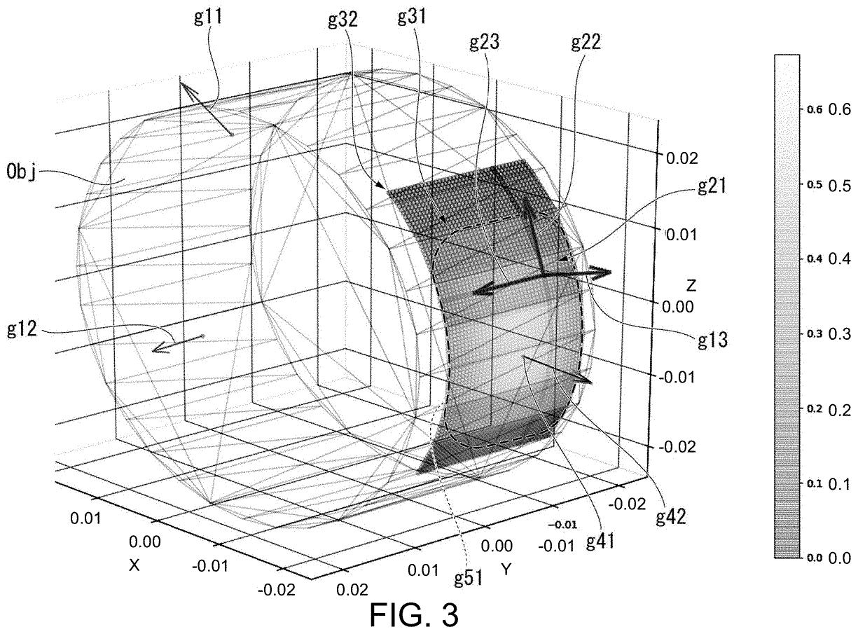

FIG. 3 is a diagram for explaining the gripping position determining process according to the present embodiment. FIG. 3 shows is an example in which an object Obj is gripped by three fingers (thumb 281a, index finger 282b, and middle finger 282c). Further, FIG. 3 shows an example of estimating and determining the gripping position where the frictional force is reduced, that is, the gripping state is stable, when the gripping positions of the index finger 282b and the middle finger 282c are not changed and the thumb 281a is moved.

An arrow g11 shows a force acting on the surface of the object Obj by the index finger 282b. An arrow g12 shows a force acting on the surface of the object Obj by the middle finger 282c. An arrow g13 shows a force acting on the surface of the object Obj by the thumb 282a at the initial position.

An arrow g21 shows a component in the z-axis direction by the thumb 282a at the initial position. An arrow g22 shows a component in the x-axis direction by the thumb 282a at the initial position. An arrow g23 shows a component in the y-axis direction by the thumb 282a at the initial position. Note that xyz are coordinates in a contact coordinate system.

In FIG. 3, each point g32 has the L2 norm, a region with a high density indicates that the value is small, and the white region indicates that the value is large. The distribution of the L2 norm is a frictional force distribution g31. Further, the region surrounded by a chain line g51 represents a grippable region.

In FIG. 3, when the object Obj is gripped, the gripping position of the thumb 281a in which the gripping state is stable is not the initial position but a correction position g42 having the largest L2 norm. An arrow g42 shows a force acting on the surface of the object Obj by the thumb 282a at the correction position.

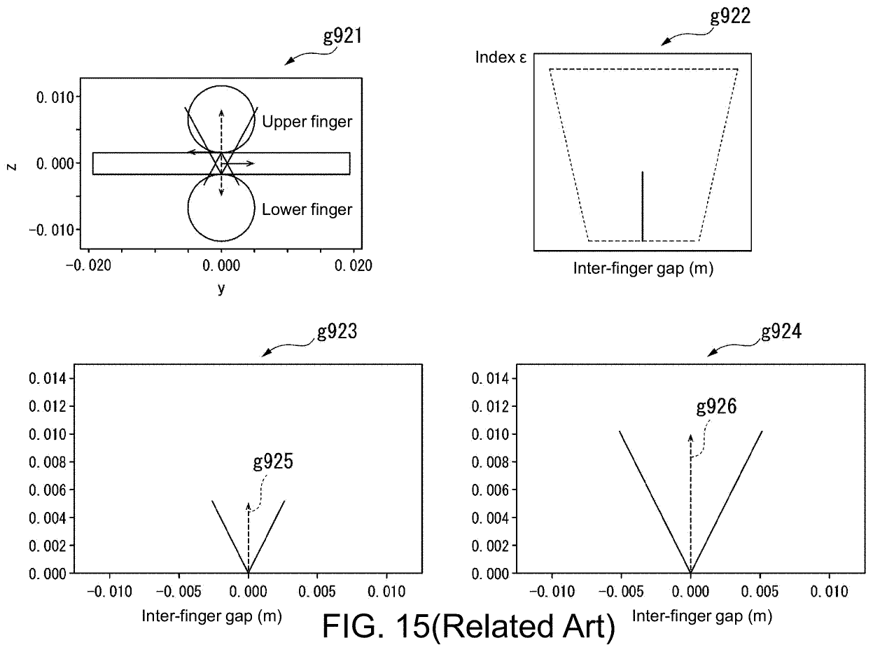

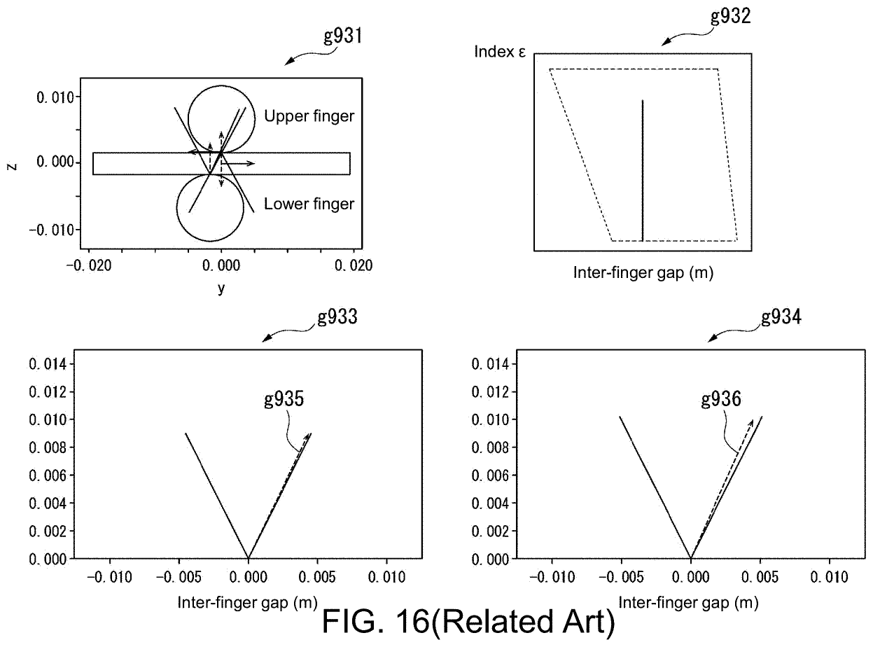

Here, the reason why the gripping position calculated by the gripping position calculation part 215 is a position where the frictional force between the object and the fingers is minimized will be described with reference to FIGS. 15 and 16 used in the description of the prior art.

When gripping a coin-shaped object with two fingers, if the two fingers to be gripped face each other via the object as shown in FIG. 15, the coin-shaped object may be gripped without using much frictional force. On the other hand, when the two fingers to be gripped do not face each other via the object and there is an inter-finger gap as shown in FIG. 16, the object cannot be gripped unless more frictional force is used than in FIG. 15.

In the graphs g923 and g924 of FIG. 15 and the graphs g933 and g934 of FIG. 16, the size of the V-shape represents the limit. Further, lines (g925, g926, g935, g936) shown between the lines on both sides of the V-shape represent the force that the robot may exert.

In the graphs g923 and g924 of FIG. 15, the lines g925 and g926 representing the force that may be exerted are substantially in the middle of the two sidelines of the V-shape.

On the other hand, in the graph g933 of FIG. 16, the line g935 representing the force that may be exerted almost overlaps with the line on the right side of the V-shape, indicating that the force that may be exerted is at the limit. Further, in the graph g934, the line g936 representing the force that may be exerted is close to the line on the right side of the V-shape, indicating that the force that may be exerted is at the limit.

An angle difference between the lines (g925, g926, g935, g936) representing the force that may be exerted and the center of the V-shape corresponds to the lateral force.

In this way, when the fingers are opposed to each other and the object is gripped while maintaining the posture, the position where the frictional force is minimized is the gripping position.

[Example of Processing Procedure for Determining Gripping Position]

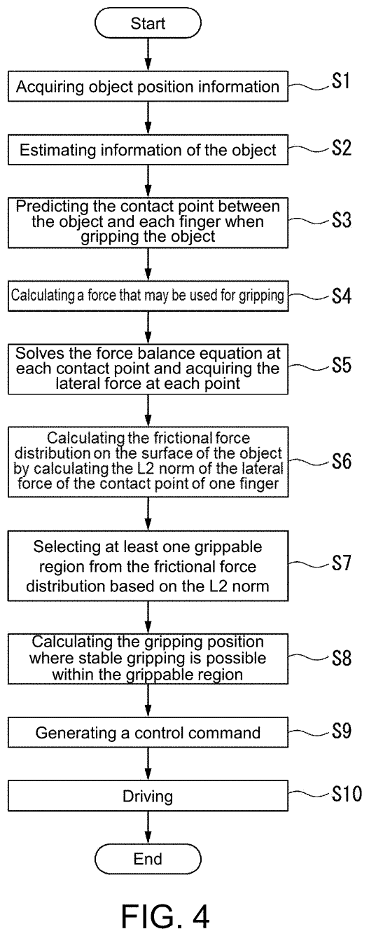

Next, an example of the processing procedure for determining the gripping position will be described. FIG. 4 is a flowchart of the processing procedure for determining the gripping position according to the present embodiment.

(Step S1) The information acquisition part 211 acquires object position information (environment sensor value) from the environment sensor 3.

(Step S2) The object estimation part 212 estimates the position, size, shape, inclination, and the like of the object to be gripped by a well-known method using the object position information.

(Step S3) The frictional force distribution calculation part 213 predicts the contact point between the object and each finger when gripping the object, based on the estimated information related to the object.

(Step S4) The frictional force distribution calculation part 213 calculates a force that may be used for gripping based on the specifications of the robot 2 and the information related to the estimated object.

(Step S5) The frictional force distribution calculation part 213 solves the balance equation G_{c}f_{c}=−Fₑ in a predetermined range from the initial gripping position for one finger, and acquires the lateral force for each gripping position candidate obtained in the solving process.

(Step S6) The frictional force distribution calculation part 213 calculates the frictional force distribution on the surface of the object by calculating the L2 norm which is the square root of the sum of squares of the obtained lateral forces.

(Step S7) The grippable region selection part 214 selects, for example, a region having the L2 norm of a predetermined value or less in the region of frictional force distribution as the grippable region.

(Step S8) The gripping position calculation part 215 searches the grippable region and calculates information such as the gripping position that can most resist the external force and the angles of the joints.

(Step S9) The control part 23 generates a control command based on the information such as the calculated gripping position and the angles of the joints.

(Step S10) The control part 23 controls the drive part 27 to drive the gripping part 28 of the robot 2 based on the generated control command.

The processing procedure described with reference to FIG. 4 is an example, and the disclosure is not limited to thereto.

[Method of Calculating L2 Norm]

Here, a method for calculating the L2 norm will be further described.

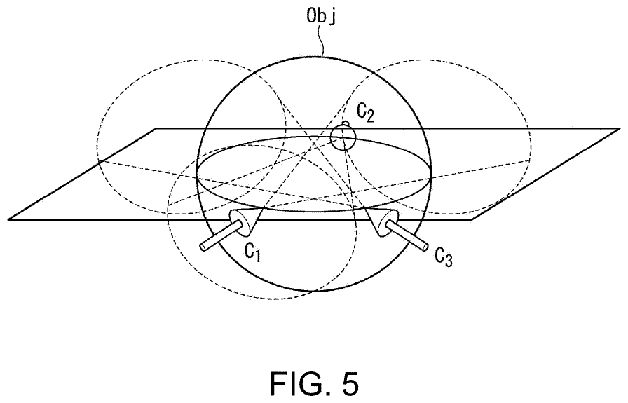

FIG. 5 is a diagram for explaining a method of calculating the L2 norm according to the embodiment. FIG. 5 is an example of gripping a spherical object with three fingers.

The frictional force distribution calculation part 213 first calculates a force G_{c}f_{c} that may be generated during gripping.

Next, the frictional force distribution calculation part 213 solves the balance equation G_{c}f_{c}=−Fₑ within a predetermined range from the contact point with respect to one finger, and acquires the lateral force for each contact point obtained in the solving process. Fₑ is an external force. The lateral force is a force parallel to the surface of the object Obj, and is a force in the lateral direction (x-axis, y-axis) in the contact point coordinate system. The sum of the lateral forces obtained in this way is the L2 norm.

### Modification Example

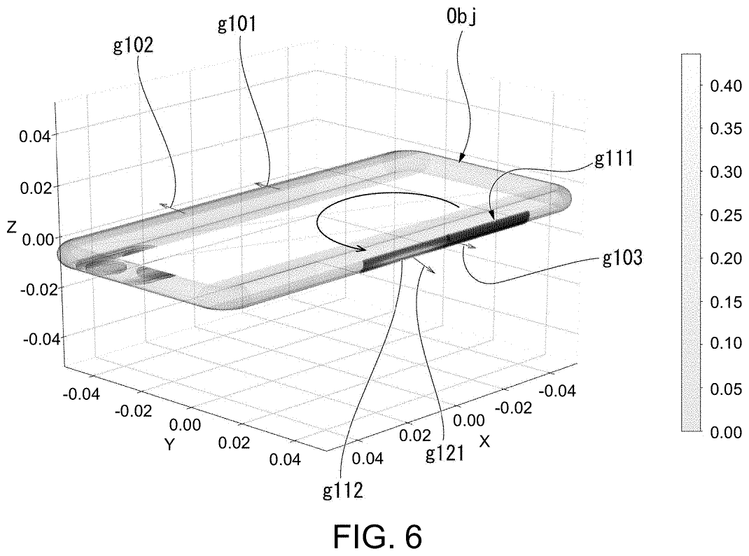

Here, an example of searching for a gripping position (correction position) to be corrected by using information related to the shape of an object will be described with reference to FIGS. 6 to 8.

FIG. 6 is a diagram showing an example of an initial gripping position, a frictional force distribution, and a correction position when gripping a smartphone having a curved surface at an edge. In the example of FIG. 6, in a state where the robot 2 grips the smartphone with the thumb 281a, the index finger 282b, and the middle finger 282c, the gripping position of the thumb 281a is corrected so that the smartphone may be gripped more stably. An arrow g101 shows a force acting on the surface of the object Obj by the index finger 282b. An arrow g102 shows a force acting on the surface of the object Obj by the middle finger 282c. An arrow g103 shows a force acting on the surface of the object Obj by the thumb 282a at the initial position.

In this case, the gripping force distribution g103 is, for example, a predetermined range of the left and right sides and the upper limit of the side surface of the smartphone centered on the thumb 282a at the initial position. Then, the gripping position calculation part 215 searches for a correction position g121 based on the L2 norm in the region of a grippable region g113.

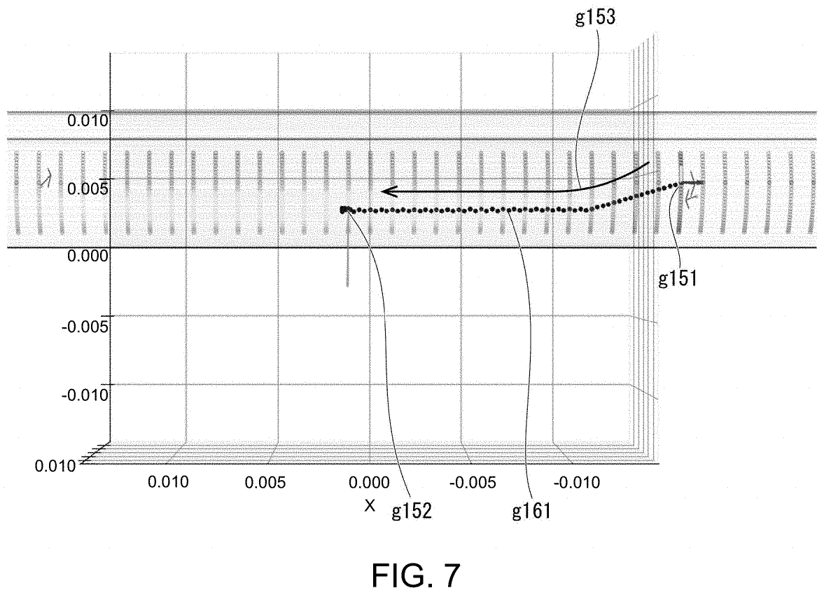

FIG. 7 is an image diagram of searching from the initial gripping position to the correction position. According to the present embodiment, instead of actually gripping the object and moving fingers on the surface of the gripped object as in the prior art, a search is made, by calculation, from the initial position g151 in the direction (search direction g153) where the cost becomes higher (the L2 norm becomes smaller). Further, point group 153 is a trajectory of a finger moved by the search. Further, point g161 is a waypoint. The trajectory is a path through which, for example, the tip of a finger should pass from the initial position (start point g151) to an end point g152. The gripping position calculation part 215 solves the equation of motion (balance equation) of the fingertip contact point at the waypoints of such a search path (via position), and calculates the optimum gripping position.

The search path in which the waypoints are set is a path that bypasses a position on the object that the finger must avoid (for example, a position where a protrusion is located). Further, the waypoints and path may be sequentially set, for example, while moving the gripping position candidate by a predetermined amount. In this case, the initial position to search is determined, but the end point is not determined.

Further, the waypoints are preferably spaced at equal intervals, but do not need to be at equal intervals.

According to the present embodiment, by searching in this way, the calculation cost of determining the gripping point in consideration of the operation can be reduced.

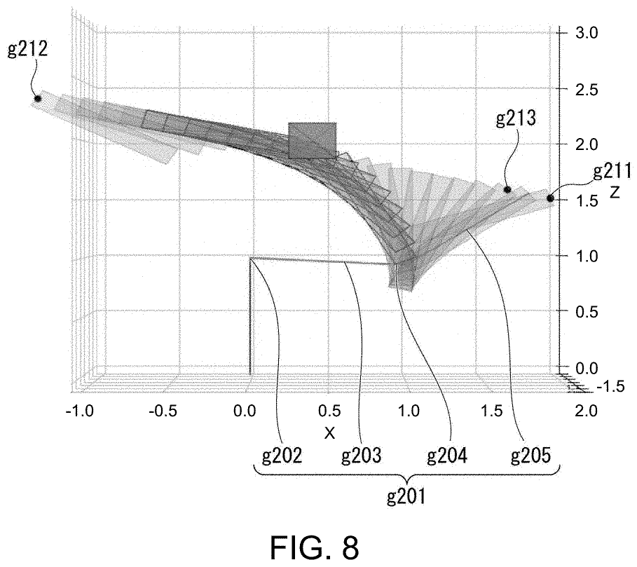

FIG. 8 is a diagram showing an example of a track and waypoints. Also, FIG. 8 is an example of gripping the surface of the object with the tip of a finger. In FIG. 8, a model g201 represents a model obtained by modelling the hand 25 including one finger part. The finger part is modeled by a first joint g202 connecting a proximal phalanx g203 and the palm, and a second joint g204 connecting a distal phalanx g205 and the proximal phalanx g203.

At the time of search, the gripping position calculation part 215 determines discrete waypoints (for example, point g213) in a trajectory where the tip of a finger should pass, for example, from the initial position (start point g211) to an end point g212. As shown in FIG. 7, the angles of the finger joints (further, the angles of joints of the hand 25) change depending on where the finger (tip, pad, etc.) is used to touch. Therefore, the gripping position calculation part 215 searches for the gripping position, obtains the angles of the joints of the hand 25 and the joints of the fingers, and outputs the obtained results to the control part 23. The number of waypoints is, for example, 100, and may be less or more. Thus, the track that the tip of the fingertip to be moved from the initial contact point to the correction position for correcting the gripping position should pass can be narrowed down within the grippable region.

Further, according to the present embodiment, it is possible to set discrete key points in the track; at the waypoint, search within a predetermined solution space using the equation of motion (an equation of motion related to the contact between a curved surface and a curved surface of an object with respect to a certain curved surface extending from the tip of a finger to the pad) of the fingertip gripping position so as to evaluate whether the total frictional force of all fingers is within an allowable range when the fingertip contact point (finger or pad) is changed; and control while modifying the contact point of the fingertip within an appropriate range.

Then, according to the present embodiment, evaluation index s is added to this equation of motion, and the grippable region is obtained from the frictional force distribution from the result of the obtained balance equation, and the optimum position in this grippable region is obtained.

As described above, according to the present embodiment, the estimated frictional force is obtained from the predictive control of the gripping force, and the frictional force distribution of a specific finger is calculated on the surface of the object from the L2 norm of the obtained frictional force of all fingers. Then, according to the present embodiment, at least one grippable region is determined from the frictional force distribution, and the contact point that can most resist the external force is calculated from the grippable regions. Further, according to the present embodiment, the gripping position in a state where the object may be stably gripped is determined without having to actually measuring the frictional force by touching.

As a result, according to the present embodiment, when operating an object, the gripping point can be determined in consideration of the operation by evaluating the entire trajectory in which the gripping position moves and rolls along the curved surface when the fingertip shape is a curved surface.

According to the method described in Patent Literature 2 of the prior art, when the surface of the object is a curved surface, the frictional force cannot be appropriately obtained even if the finger in contact with the object is moved. On the other hand, according to the present embodiment, the frictional force is acquired without having to actually move the fingers to touch the object, since the frictional force in the gripped state is predicted and the contact point that can most resist the external force is calculated, the gripping position where stable gripping is possible can be appropriately determined.

### Second Embodiment

According to the present embodiment, in order to further maintain the posture and movement of the object in a specific state, a gripping position reflecting a specific condition (for example, gravity) is calculated. In this case, the gripping position is not always the position where the frictional force is minimized. In the present embodiment, a state in which the object is gravitationally balanced and may be gripped, a state in which the object may be gripped even if the posture of the object is tilted or the like is included.

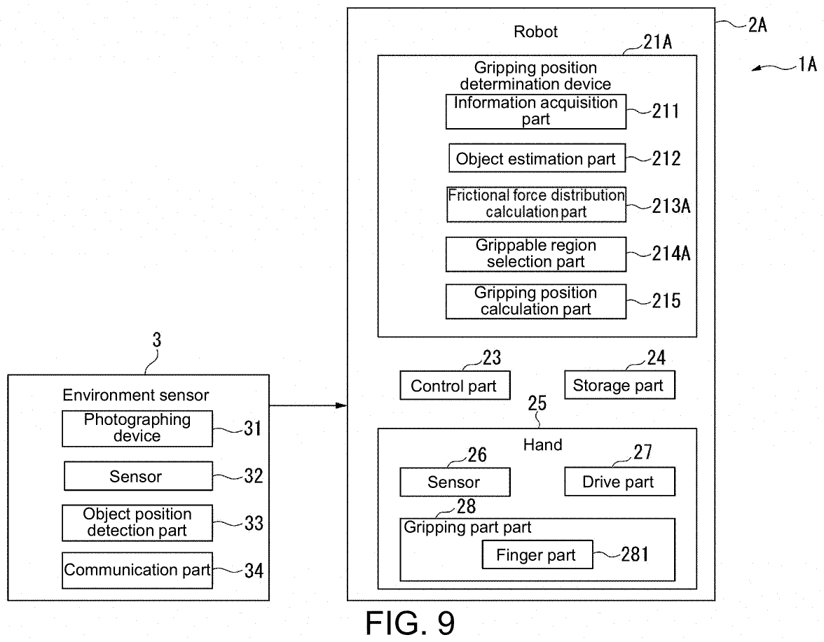

FIG. 9 is a block diagram showing a configuration example of the gripping position determination system according to the present embodiment. As shown in FIG. 9, a gripping position determination system 1A includes a robot 2A and the environment sensor 3.

The robot 2A includes a gripping position determination device 21A, a control part 23, a storage part 24, and the hand 25.

The gripping position determination device 21A includes the information acquisition part 211, the object estimation part 212, a frictional force distribution calculation part 213A, a grippable region selection part 214A, and the gripping position calculation part 215.

The frictional force distribution calculation part 213A determines whether or not there is a grippable region that may be gripped in a specific state based on constraint conditions.

The grippable region selection part 214A selects at least one grippable region within the region of the frictional force distribution based on the constraint conditions and the L2 norm. The constraint conditions may be, for example, the force that the hand 25 may exert, the minimum force that each finger exerts evenly, whether or not the posture is maintained, and the like.

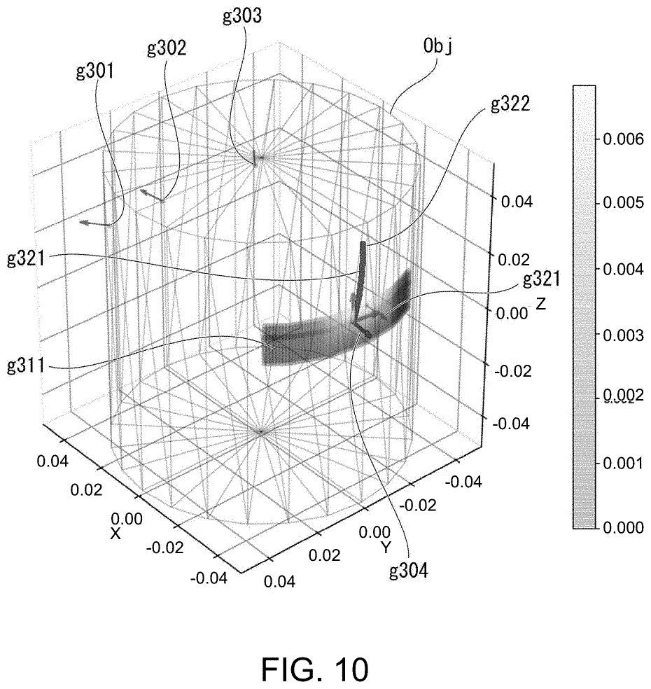

FIG. 10 is a diagram for explaining an example of determining a gripping position according to the present embodiment. In FIG. 10, the object Obj is a cylindrical object. Further, FIG. 10 is an example of gripping from above with four fingers (thumb, index finger, middle finger, and ring finger).

Position g301 is the gripping position of the index finger 282b. Position g302 is the gripping position of the middle finger 282c. Position g303 is the gripping position of the ring finger 282d. Position 304 is the initial gripping position of the thumb 282a. Each arrow represents the force acting on the object Obj when gripped by each finger.

Here, in a case when the gravitational balance of the object Obj is not disturbed, that is, when the object is gripped so as not to tilt, the initial gripping position of the thumb 282a is a position facing the gripping position of the index finger 282b, the gripping position of the middle finger 282c, and the gripping position of the ring finger 282d. In this case, the frictional force distribution calculation part 213 calculates a gripping force distribution g311 in a predetermined range in the xy direction of the object Obj, that is, in the circumferential direction. Then, the gripping position determination device 21A calculates a correction gripping position g312 as a position where stable gripping is possible.

Next, in a case when the gravitational balance of the object Obj may be disturbed, that is, when the object is gripped such that it may be tilted, with respect to a position where the object Obj can be stably gripped, including a predetermined range in the z-axis direction of the object Obj, the gripping position determination device 21A searches for a position on the surface of the object Obj where the L2 norm is minimized (search path g321), and calculate the gripping position g322.

[Example of Frictional Force Distribution]

Next, an example of the frictional force distribution according to the present embodiment will be described.

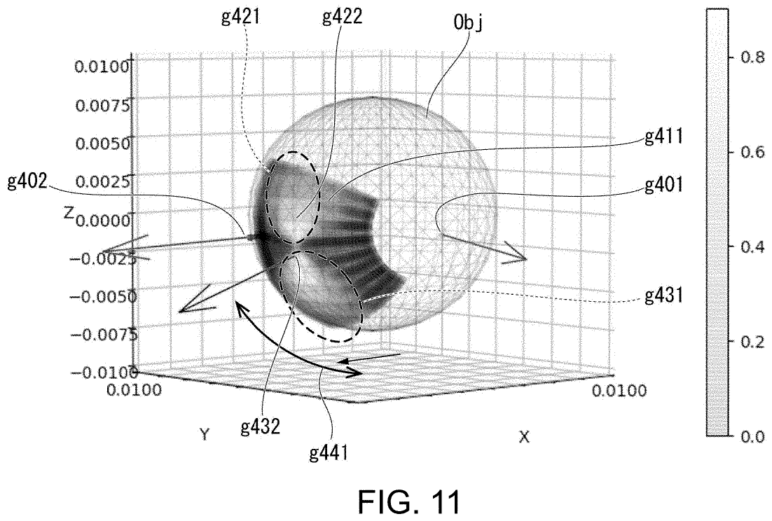

FIG. 11 is a diagram showing an example of the frictional force distribution according to the present embodiment. In FIG. 11, the object Obj is a spherical object. Further, FIG. 11 is an example of gripping from the side surface side with two fingers (thumb and index finger).

Position g401 is the gripping position of the index finger 282b. Position 402 is the initial gripping position of the thumb 282a. Each arrow represents the force acting on the object Obj when gripped by each finger.

In this case, a frictional force distribution g411 is distributed not only in the xy direction of the object Obj but also in the z-axis direction.

A first grippable region g421 is a region based on the L2 norm. In the first grippable region g421, the gripping position where stable gripping is possible is a position g422. This position g422 is a position facing the index finger and is selected, for example, when the influence of gravity is weakened.

A second grippable region g431 is a region when the case where the grip is gravitationally stable is also considered as a constraint conditions. In the second grippable region g431, the gripping position where stable gripping is possible is position g432. The position g432 is a position that is stable in the direction of gravity even slightly below the position g422, and is selected, for example, when a change in the posture of the object or the like is allowed.

Furthermore, as shown by an arrow g441, the range of the grippable region represents the grippable region.

According to the present embodiment, at least one grippable region is determined from the frictional force distribution, and the contact point that can most resist gravity and external force is calculated from the region. Then, according to the present embodiment, from at least one grippable region, the position where the frictional force does not occur as much as possible in the lateral direction of an object by all fingers is searched for and corrected by moving the initial gripping position of one finger.

[Example of Processing Procedure for Determining Gripping Position]

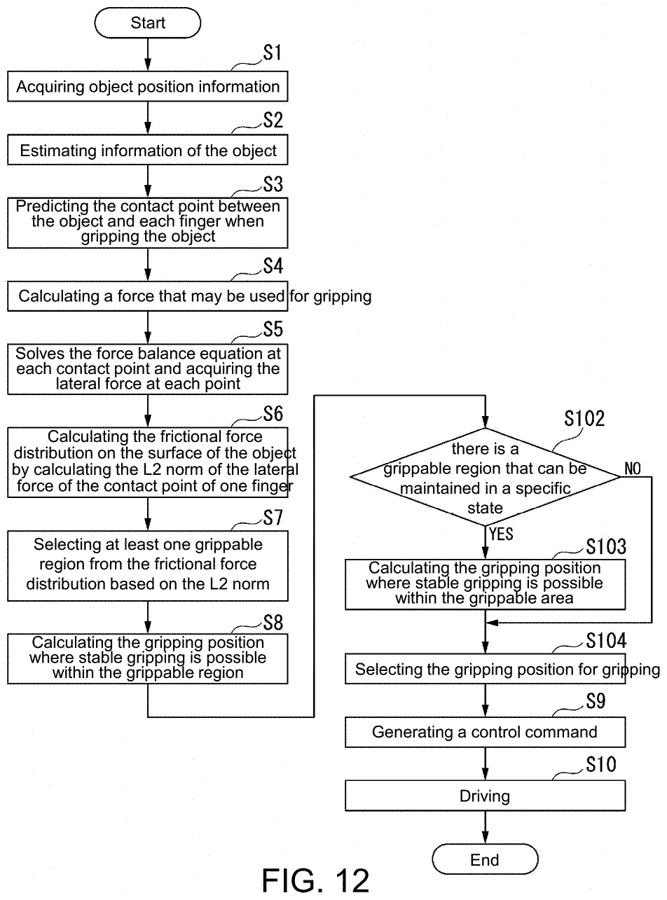

Next, an example of the processing procedure for determining the gripping position will be described. FIG. 12 is a flowchart of the processing procedure for determining the gripping position according to the present embodiment.

(Steps S1 to S5) The gripping position determination device 21A performs the processes of steps S1 to S5.

(Step S101) The frictional force distribution calculation part 213 calculates the frictional force distribution on the surface of the object by calculating the L2 norm which is the square root of the sum of squares of the obtained lateral forces.

(Steps S7 to S8) The gripping position determination device 21A performs the processes of steps S7 to S8.

(Step S102) The frictional force distribution calculation part 213A determines whether or not there is a grippable region where gripping is possible in a specific state based on constraint conditions. When the frictional force distribution calculation part 213A determines that there is a grippable region where gripping is possible in a specific state (step S102; YES), the process proceeds to step S103. When the frictional force distribution calculation part 213A determines that there is no grippable region where gripping is possible in a specific state (step S102; NO), the process proceeds to step S104.

(Step S103) The gripping position calculation part 215 searches for a grippable region and calculates information such as other gripping positions that can most resist an external force and the angles of the finger joints.

(Steps S9 to S10) The control part 23 performs the processes of steps S9 to S10.

The frictional force distribution calculation part 213A performs the processes of steps S102 to S103 on all the grippable regions where gripping is possible in a specific state.

Thus, according to the present embodiment, when there are a plurality of gripping methods in which external force and gravity are balanced, one is selected from a plurality of grippable regions one by one, and the gripping position is calculated for each selected grippable region. The gripping position calculation part 215 selects one gripping position from the plurality of gripping positions calculated in this way according to the state of the object, the constraint conditions, and the like.

Thereby, it is possible to determine a plurality of gripping positions where stable gripping is possible. As a result, according to the present embodiment, the evaluation considering the error of the gripping position can be considered as the expected value considering the probability distribution, and by treating the shape elements on the fingertip side and the crushing of the epidermis and the like as a distribution, it is possible to evaluate without tuning the parameters of the weighting while considering a plurality of elements.

Also, when the posture of the like of the object changes (for example, when carrying) with respect to the two or more gripping positions described above, the gripping position selected from the plurality of calculated gripping positions may be switched according to the posture or the like of the object.

When operating an object, the gripping point moves while rolling when the fingertip shape is a curved surface. As described above, according to the first embodiment and the second embodiment, it is possible to determine the gripping point in consideration of the operation by evaluating the entire trajectory. In addition, since the evaluation considering the error of the gripping position can be considered as the expected value considering the probability distribution, as described above, according to the first embodiment and the second embodiment, by treating the shape elements on the fingertip side and the crushing of the epidermis or the like as a distribution, it is possible to evaluate without tuning the parameters of the weighting while considering a plurality of elements.

Further, according to the first embodiment and the second embodiment, unlike the evaluation of gripping performance by all fingers as described in the prior art, information on the frictional force of all fingers incorporated into the evaluation of the goodness of the contact point of one finger, and the contact point can be determined from the distribution on the surface of the object. As a result, according to the first embodiment and the second embodiment, the non-slip position can be determined more specifically.

Further, according to the first embodiment and the second embodiment, by performing the evaluation considering the error of the gripping position at the time of actual gripping in the direction of making it easy to stay inside a grippable ellipsoid, it is possible to determine a robust gripping position even if there is an error in the shape or control.

Moreover, a program for realizing all or part of the functions of the gripping position determination device 21 (or 21A) according to the disclosure may be recorded on a computer-readable recording medium, and the program recorded on the recording medium may be read into the computer system and executed, so as to perform all or part of the processing performed by the gripping position determination device 21 (or 21A). The term “computer system” as used herein includes hardware such as an operating system (OS) and peripheral devices. Moreover, the “computer system” includes systems built on a local network, system built on the clouds, and the like. Further, the “computer-readable recording medium” refers to portable media such as a flexible disk, a magneto-optical disk, a read-only memory (ROM), or a compact disk read-only memory (CD-ROM), and storage devices such as a hard disk built in a computer system. Furthermore, a “computer-readable recording medium” also includes a server when a program is transmitted via a network such as the Internet or a communication line such as a telephone line, or media that hold a program for a certain period of time, such as a volatile random access memory (RAM) inside that computer system that serves as a client.

Further, the program may be transmitted from a computer system in which this program is stored in a storage device or the like to another computer system via a transmission medium or by a transmission wave in the transmission medium. Here, the “transmission medium” for transmitting a program refers to a medium having a function of transmitting information, such as a network (communication network) such as the Internet or a communication line (communication line) such as a telephone line. Moreover, the above program may be for realizing some of the above-mentioned functions. Further, it may be a so-called difference file (difference program) that can realize the above-mentioned function in combination with a program already recorded in the computer system.

The embodiments for carrying out the disclosure have been described above using the embodiments, but the disclosure is not limited to these embodiments. Various modifications and substitutions can be added without departing from the gist of the disclosure.

(2) Further, in the gripping position determination device according to one aspect of the disclosure, the frictional force distribution calculation part calculates, from an initial gripping position at which one of the gripping fingers grips the object, the frictional force distribution within a predetermined range, and the gripping position calculation part searches within the frictional force distribution from the initial gripping position to calculate a gripping position where stable gripping is possible against an external force.

(3) Further, in the gripping position determination device according to one aspect of the disclosure, the gripping position calculation part selects the grippable region where maintenance of posture and movement of the object in a specific state is possible, and calculates a gripping position in the selected grippable region where maintenance of posture and movement of the object in a specific state is possible.

(4) Further, in the gripping position determination device according to one aspect of the disclosure, the frictional force distribution calculation part calculates a force that the robot hand is capable of exerting, and estimates the frictional force by solving a balance equation between the calculated force that the robot hand is capable of exerting and an external force that is predicted when the object is gripped.

(5) Further, in the gripping position determination device according to one aspect of the disclosure, the gripping position calculation part calculates a state of each joint of the gripping fingers when the object is gripped at the gripping position.

(6) Further, in the gripping position determination device according to one aspect of the disclosure, the gripping position calculation part takes the initial gripping position as a start point, and searches for a most stable gripping position among discrete positions between the start point and an end point up to a predetermined position in the gripping region.

(7) Further, in the gripping position determination device according to one aspect of the disclosure, the gripping position calculation part takes the initial gripping position as a start point, and searches for a most stable gripping position in each position separated by a predetermined distance from the start point.

According to (1) to (10), the gripping point can be determined in consideration of the operation. Further, according to (1) to (10), a robust gripping position can be determined even if there is an error in shape or control.

Further, according to (3), the non-slip position can be determined more specifically.

Further, according to (5), the robot hand can accurately grip the gripping point in consideration of the operation.

Further, according to (6) and (7), the calculation cost of determining the gripping point in consideration of the operation can be reduced.

What is claimed is:

1. A gripping position determination device for a robot hand having a plurality of multi-joint fingers, the gripping position determination device comprising:
a frictional force distribution calculation part that estimates, from a predictive control of a gripping force when an object is gripped by at least two of the plurality of fingers, a frictional force between one of the gripping fingers and the object, and calculates a frictional force distribution where gripping of the object is possible on a surface of the object based on a value related to a frictional force calculated by using the estimated frictional force;
a grippable region selection part that selects, from the frictional force distribution, at least one grippable region; and
a gripping position calculation part that calculates, from the selected grippable region, a gripping position where stable gripping of the object is possible.

2. The gripping position determination device according to claim 1,
wherein the frictional force distribution calculation part calculates, from an initial gripping position at which one of the gripping fingers grips the object, the frictional force distribution within a predetermined range, and
the gripping position calculation part searches within the frictional force distribution from the initial gripping position to calculate a gripping position where stable gripping is possible against an external force.

3. The gripping position determination device according to claim 1,
wherein the gripping position calculation part selects the grippable region where maintenance of posture and movement of the object in a specific state is possible, and calculates a gripping position in the selected grippable region where maintenance of posture and movement of the object in a specific state is possible.

4. The gripping position determination device according to claim 1,
wherein the frictional force distribution calculation part calculates a force that the robot hand is capable of exerting, and estimates the frictional force by solving a balance equation between the calculated force that the robot hand is capable of exerting and an external force that is predicted when the object is gripped.

5. The gripping position determination device according to claim 1,
wherein the gripping position calculation part calculates a state of each joint of the gripping fingers when the object is gripped at the gripping position.

6. The gripping position determination device according to claim 2,
wherein the gripping position calculation part takes the initial gripping position as a start point, and searches for a most stable gripping position among discrete positions between the start point and an end point up to a predetermined position in the gripping region.

7. The gripping position determination device according to claim 2,
wherein the gripping position calculation part takes the initial gripping position as a start point, and searches for a most stable gripping position in each position separated by a predetermined distance from the start point.

8. A gripping position determination system, comprising:
the gripping position determination device according to claim 1;
a robot hand having a plurality of multi joint fingers;
an environment sensor installed in a robot comprising the robot hand or in a surrounding environment of the robot and detecting a robot environment sensor value; and
a control part that controls, based on the gripping position determined by the gripping position determination device, a movement of the robot hand so as to grip the object.

9. A gripping position determination method for a robot hand having a plurality of multi joint fingers, the gripping position determination method comprising:
a frictional force distribution calculation part estimating, from a predictive control of a gripping force when an object is gripped by at least two of the plurality of fingers, a frictional force between one of the gripping fingers and the object, and calculating a frictional force distribution where gripping of the object is possible on a surface of the object based on a value related to a frictional force calculated by using the estimated frictional force;
a grippable region selection part selecting, from the frictional force distribution, at least one grippable region; and
a gripping position calculation part calculating, from the selected grippable region, a gripping position where stable gripping of the object is possible.

10. A recording medium, recording a program, causing a computer of a gripping position determination device of a robot hand having a plurality of multi joint fingers to
estimate, from a predictive control of a gripping force when an object is gripped by at least two of the multiple fingers, a frictional force between one of the gripping fingers and the object, and calculate a frictional force distribution where gripping of the object is possible on a surface of the object based on a value related to a frictional force calculated by using the estimated frictional force;
select, from the frictional force distribution, at least one grippable region; and
calculate, from the selected grippable region, a gripping position where stable gripping of the object is possible.
